(19) United States
(12) Patent Application Publication
(10) Pub. No.: US 2021/0272023 A1
(43) Pub. Date: Sep. 2, 2021

(54) INFORMATION PROCESSING SYSTEM AND INFORMATION PROCESSING METHOD

(71) Applicants: Kabushiki Kaisha Toshiba, Tokyo (JP); Toshiba Digital Solutions Corporation, Kawasaki-shi (JP)

(72) Inventors: Yuki Matsuoka, Toshima (JP); Minoru Nishizawa, Kita (JP); Tetsuya Gotou, Minato (JP); Yoshiyuki Tsuzuki, Kawasaki (JP)

(73) Assignees: Kabushiki Kaisha Toshiba, Tokyo (JP); Toshiba Digital Solutions Corporation, Kawasaki-shi (JP)

(21) Appl. No.: 17/320,743

(22) Filed: May 14, 2021

Related U.S. Application Data
(63) Continuation of application No. PCT/JP2019/045051, filed on Nov. 18, 2019.

(30) Foreign Application Priority Data
Nov. 20, 2018 (JP) 2018-217271

(51) Int. Cl. G06N 20/00; G06F 3/0484; G06F 8/35

(52) U.S. Cl. CPC G06N 20/00; G06F 8/35; G06F 3/04847

(57) ABSTRACT

According to one embodiment, an information processing system includes an acquisition unit, an environment setting unit, a model processing unit, a management unit, an interface unit, and a control unit. The acquisition unit acquires design information and target data of machine learning. The environment setting unit sets a framework environment and library information executing the design information, and sets a software configuration supporting execution of the machine learning. The model processing unit generates or updates a model by executing learning for the target data using the design information and framework environment. The management unit manages design information, information about the framework environment and information about the model. The interface providing unit receives, from a user, an output instruction for the environment setting information, and presents, to the user, setting information or the like being recommended.

### CROSS-REFERENCE TO RELATED APPLICATION(S)

This application is based upon and claims the benefit of priority from PCT Application No. PCT/JP2019/045051 filed on Nov. 18, 2019, which is based upon and claims the benefit of priority from Japanese Patent Application No. 2018-217271 filed in Japan on Nov. 20, 2018; the entire contents of (all of) which are incorporated herein by reference.

### FIELD

Embodiments described herein relate generally to an information processing system and an information processing method.

### BACKGROUND

Conventionally, technologies related to model integration systems for updating models and improving the accuracy of models based on common models generated by deep learning utilizing neural networks are known.

In recent years, new learning model generation modules and library information have been released daily in the form of open source. These generated modules, library information, etc. may be released by volunteers to a large number of developers after being combined and packaged in a state where they function properly, and efforts have been made to save the trouble of building an environment for each developer and to improve the efficiency of development.

In the conventional technology, standardization of a model development technique while incorporating new generation module and library information may not have been sufficiently considered.

### BRIEF DESCRIPTION OF THE DRAWINGS

FIG. 1 is a diagram showing a configuration of an information processing system 1 according to an embodiment.

FIG. 2 is a diagram showing an example of a learning/inference processing flow of a model implemented in the information processing system 1.

FIG. 3 is a diagram showing an outline of processing of the information processing system 1.

FIG. 4 is a diagram for explaining a usage case of the information processing system 1.

FIG. 5 is a diagram showing a specific example of a usage case of the information processing system 1.

FIG. 6 is a flowchart showing an example of a flow of learning processing by a model processing unit 150.

FIG. 7 is a flowchart showing an example of a processing flow of a virtualization platform C-1.

FIG. 8 is a diagram showing an example of the contents of a trained model 187.

FIG. 9 is a diagram showing an example of the contents of user information 184.

FIG. 10 is a flowchart showing an example of a flow of interface providing processing by a management unit 160 and an interface providing unit 170.

### DETAILED DESCRIPTION

According to an aspect, an information processing system includes an acquisition unit, an environment setting unit, a model processing unit, a management unit, an interface providing unit, and a control unit. The acquisition unit acquires design information for machine learning and target data for the machine learning. The environment setting unit sets a framework environment and library information for executing the design information acquired by the acquisition unit, and a software configuration for assisting an execution of the machine learning in the framework environment according to version information of the framework environment and the library information. The model processing unit generates or updates a model by executing learning for the target data using the design information acquired by the acquisition unit and the framework environment set by the environment setting unit. The management unit manages the design information acquired by the acquisition unit, information on the framework environment set by the environment setting unit, and information on the model generated or updated by the model processing unit as development history information. The interface providing unit receives an output instruction of environment setting information from a user of the own system, presents the setting information recommended to the user, and causes the environment setting unit to set the environment based on the setting information selected by the user. The control unit links the acquisition unit, the environment setting unit, the management unit, and the interface providing unit.

Hereinafter, the information processing system and the information processing method of the embodiment will be described with reference to the drawings.

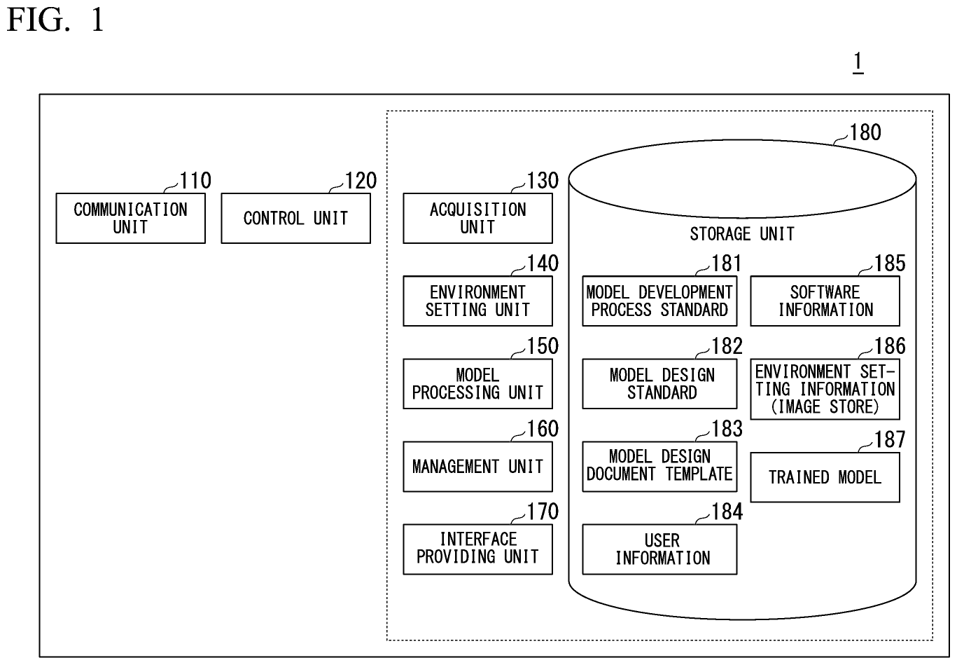

FIG. 1 is a diagram showing a configuration of an information processing system 1 according to an embodiment. The information processing system 1 includes, for example, a communication unit 110, a control unit 120, an acquisition unit 130, an environment setting unit 140, a model processing unit 150, a management unit 160, an interface providing unit 170, and a storage unit 180. Some or all of these components except the model processing unit 150 and the storage unit 180 may be realized by executing a program stored in the storage unit 180 by a processor such as a CPU (Central Processing Unit). In addition, some or all of the components of the control unit 120 are hardware (including circuit unit; circuitry) such as LSI (Large Scale Integration), ASIC (Application Specific Integrated Circuit), FPGA (Field-Programmable Gate Array), or may be realized by the cooperation of software and hardware. The program may be stored in advance in a storage device (a storage device including a non-transient storage medium) such as an HDD (Hard Disk Drive) or a flash memory, or may be stored in a removable storage medium (non-transient storage medium) such as a DVD or a CD-ROM to be installed by mounting the storage medium in a drive device. The function of the control unit 120 is realized by the processor executing the program stored in the storage unit 180.

The communication unit 110 communicates with an external device such as a terminal device (for example, a personal computer or a tablet terminal) of a user of the information processing system 1 (referring to a general system developer, the same applies in the present application) via a network, to transmit and receive information. The network includes some or all of a LAN (Local Area Network), a WAN (Wide Area Network) Internet, a dedicated line, a wireless base station, a provider, and the like. The communication unit 110 acquires design information (for example, a coding program created by the user), target data, and the like transmitted by a terminal device (not shown) of the user. Further, the communication unit 110 outputs the trained model or the like output by the control unit 120 to the external device such as a user's terminal device.

The control unit 120 controls the input/output of information of each component, and more specifically, the acquisition unit 130, the environment setting unit 140, the management unit 160, and the interface providing unit 170 are linked. The control unit 120 outputs, for example, the information received by the communication unit 110 to the acquisition unit 130 and the management unit 160. Further, the control unit 120 outputs to the communication unit 110, for example, the setting of the development environment for generating the trained model generated by the model processing unit 150 and the trained model provided by the interface providing unit 170 and the copy of the development environment, to transmit to the external device.

Further, the control unit 120 outputs the instruction of the user of the information processing system 1 received via the communication unit 110 to each component. Further, the control unit 120 has three core assets (details of each core asset will be described later), that is, a “development framework” that defines an interface, a “development component” that is a group of software components, and a “development environment” that is an execution environment of a product are linked. The control unit 120 transmits the learning data and the evaluation data acquired by the acquisition unit 130 to the model processing unit 150, in the learning environment that is set by the acquisition unit 130 and the environment setting unit 140, and executes learning.

The acquisition unit 130 acquires the design information for machine learning and the target data output by the control unit 120.

The acquisition unit 130 may be “acquired from another functional unit” or may be “acquired by self-generating/processing” the acquired information. For example, the acquisition unit 130 acquires software information 185, which will be described later, and performs processing such as cleansing or denoise of the target data, to acquire the necessary target data.

The environment setting unit 140 performs the environment setting based on the user's instruction regarding the environment setting output by the control unit 120. Here, the environment setting includes, for example, a combination (hereinafter sometimes referred to as framework environment) of the type of program language to be used, OSS (Open Source Software) for machine learning, host OS (Operating System) for machine learning, or the like and changes in library information, parameters, or the like to be referenced in the framework environment. The environment setting unit 140 stores the set development environment in the storage unit as environment setting information 186 in a container format (image copy), for example. The host OS may not be essential.

The environment setting unit 140 may set the OSS configuration according to the framework environment and the library information based on the version information of the framework environment and the library information in the environment setting. In general, there are many types of OSS library information for machine learning, and the required software configuration differs depending on the library to be adopted and its version. The environment setting unit 140 realizes such a software configuration without the intervention of the user (or by omitting the operation of the user).

The environment setting unit 140 may provide a standardized development environment recommended by the administrator of the information processing system 1 when the user does not particularly request it. At that time, the environment setting unit 140 may accept the request for the change of the setting by the user and provide the environment setting reflecting the received change content. The recommended development environment will be described later.

The model processing unit 150 generates a model for learning the design information and target data for machine learning acquired by the acquisition unit 130 in the environment set by the environment setting unit 140, and stores the generated model in the storage unit 180 as the trained model 187. Hereinafter, these processes by the model processing unit 150 may be referred to as “learning processing”.

In addition, the model processing unit 150 performs inference processing using the generated trained model 187. The inference processing will be described later.

Operations such as learning processing and inference processing by the model processing unit 150 are realized by, for example, a processor of a server (hereinafter, GPU server) equipped with a GPU (Graphic Processing Unit), which enables high-speed learning processing, executing the program stored in the storage unit 180.

The management unit 160 manages the correspondence between the design information, the environment setting in which the design information is executed, and the trained model as a result of executing the setting information in the environment. The management unit 160 manages, for example, what kind of changes the user has made to the environment when the development environment standardized by the environment setting unit 140 is provided.

The interface providing unit 170 provides the development environment to the user based on the user's instruction output by the control unit 120. Details will be described later.

The storage unit 180 may be realized by, for example, a non-volatile storage medium such as a ROM (Read Only Memory), a flash memory, an HDD (Hard Disk Drive), an SD card, and an MRAM (Magnetoresistive Random Access Memory), and a volatile storage medium such as a RAM (Random Access Memory) and a register. The storage unit 180 stores the program executed by the processor and also stores the processing result by the control unit 120 and the like.

The storage unit 180 stores, for example, model development process standard 181, model design standard 182, model design document template 183, user information 184, software information 185, environment setting information 186, trained model 187, and the like. Various types of information stored in the storage unit 180, particularly software information 185, are stored, for example, by adding/updating a new OSS by the administrator of the information processing system 1 or original software provided to the user of the information processing system 1 is stored.

In the following description, the learning processing by the model processing unit 150 will be described as being realized by a neural network having a multi-layer structure, but the learning processing is not limited to this. A multi-layered neural network is composed of, for example, an input layer, an output layer, a hidden layer, etc., and each layer is connected by a weighted edge that represents the strength of the connection between the nodes.

### [Flow of Learning/Inference Processing]

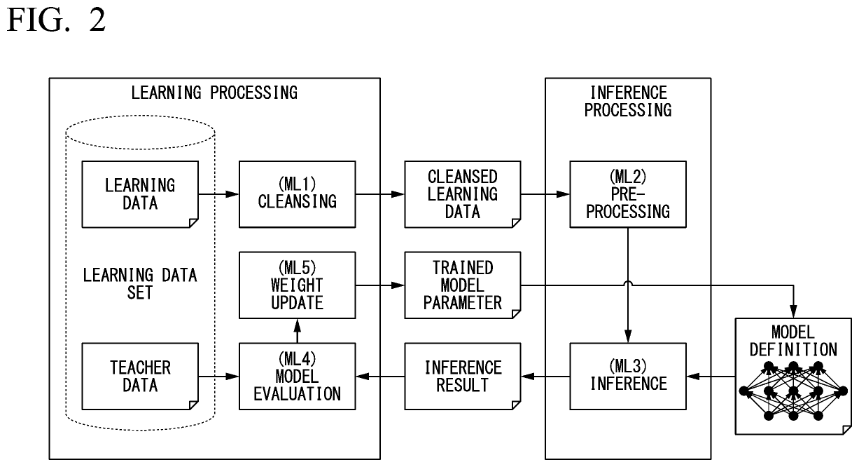

FIG. 2 is a diagram showing an example of a learning/inference processing flow of a machine learning model implemented in the information processing system 1.

The learning/inference processing of machine learning in the development framework is realized by, for example, five-step processing of (ML1) to (ML5) as shown below. (ML1), (ML4) and (ML5) shown in FIG. 2 correspond to steps for explaining the learning processing. Further, (ML2) and (ML3) shown in FIG. 2 correspond to steps explaining the inference processing.

### (ML1) Cleansing Step

The acquisition unit 130 cleanses the acquired target data. Cleansing is, for example, performing removal processing for detecting and removing foreign data, correction processing for eliminating errors in target data, interpolation processing for insufficient data, and the like.

### (ML2) Pre-Processing Step

The acquisition unit 130 acquires target data suitable for machine learning by performing processing such as normalizing the value of the target data.

### (ML3) Inference Step

The model processing unit 150 acquires the target data that has been cleansed and pre-processed from the acquisition unit 130, and further performs inference processing after setting the environment, model definition, etc. set by the user in the environment setting unit 140. The model processing unit 150 gives target data to a predefined model definition according to, for example, the type of target data (for example, image, sensor data, etc.) and analysis problem (for example, regression, classification, etc.), thereby outputting the inference result.

### (ML4) Model Evaluation Step

The model processing unit 150 calculates the error between the output data from the trained model 187 and the teacher data (correct answer) with respect to the input data, and sets an index for evaluating the accuracy of the trained model 187.

### (ML5) Weight Update Step

The model processing unit 150 updates the weight of each edge to an appropriate value little by little so that the error calculated in the model evaluation step is reduced.

The model processing unit 150 repeatedly executes the processes corresponding to the above steps (ML3) to (ML5) to generate the optimum trained model 187.

The information processing system 1 provides users with the processing flows shown in the above steps (ML1) to (ML5) and development standards (described later) corresponding to the processing flows, thereby intending to make the design uniform. Further, the information processing system 1 can improve maintainability and expandability of various modules by commonly managing modules such as model definitions and pre-processing that are commonly used in both learning processing and inference processing.

### [Outline of Information Processing System 1]

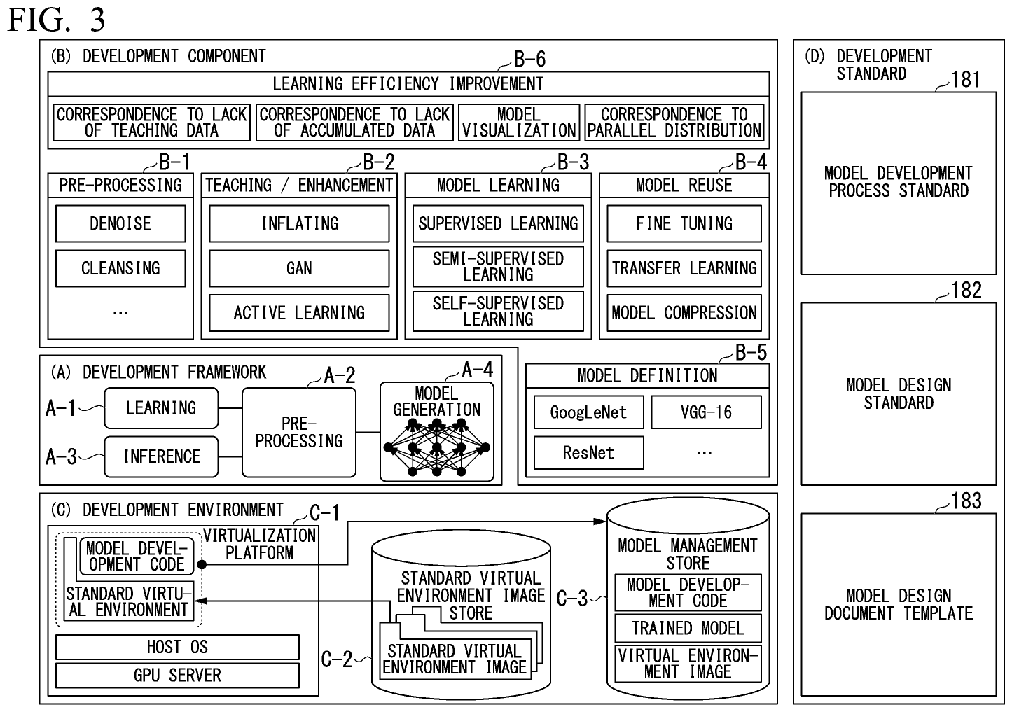

FIG. 3 is a diagram showing an outline of processing of the information processing system 1. The processing in the information processing system 1 can be described, for example, in the steps (A) to (D) shown in FIG. 3.

### [Development Framework]

The development framework (A) shown in FIG. 3 defines an interface of a module that implements each processing of learning and inference in machine learning shown in FIG. 3. The development framework is composed of, for example, a learning processing A-1, a pre-processing A-2, an inference processing A-3, and a model generation processing A-4. The user implements the model using the development framework. Each processing of the development framework is realized by, for example, the acquisition unit 130, the environment setting unit 140, and the model processing unit 150. Further, the learning processing A-1 by the trained model generated by the development framework is executed in the model processing unit 150 by calling the trained model 187 and the like stored in the storage unit 180 by the control unit 120.

The information processing system 1 promotes uniform design of typical processing in the development framework by providing the development standard (D) described later. Further, the information processing system 1 separates and standardizes the model definition and pre-processing modules that can be commonly used in both the learning processing A-1 and the inference processing A-3, thereby improving maintainability and expandability.

### [Development Components]

The development component (B) shown in FIG. 3 is a group of functions provided in the process of preparing for the generation of the trained model, such as conditioning the target data for performing machine learning in the above-described development framework and setting the learning method. The development component is realized, for example, by calling the software of the software information 185 by the control unit 120.

In the development component, for example, as pre-processing B-1 for the target data, denoise processing (processing to remove noise), cleansing processing (processing such as removing foreign data and organizing data such as error correction and interpolation of missing data) are performed, and as the teaching/enhancement processing B-2 of the target data, data inflating, feature extraction by GANs (Generative Adversarial Networks), data organization using an active learning framework, etc. are performed.

In the development component, instructions from the user are accepted such as selection of model learning method B-3 (for example, supervised learning, semi-supervised learning, self-supervised learning, etc.), condition setting of model reuse B-4, and selection of model definition B-5 (for example, GoogleLeNet model, ResNet model, VGG-16 model, etc.) by the user. Condition setting is to provide functions such as fine tuning, which is a method of reusing part of an existing trained model 187 to build a new model, transfer learning, which uses the trained model 187 that has been trained in advance in another learning, and model compression, which is used by compressing the trained model 187 to the extent that the accuracy is not reduced.

Setting of the development component may be performed by setting a recommended combination in advance by the administrator of the information processing system 1 and providing the combination as setting information of learning efficiency improvement B-6 to the user. For example, when “correspondence to lack of teaching data” is selected by the user in learning efficiency improvement B-6, a setting is provided equivalent to the setting in a state in which various processes of B-1 to B-5, which are set by the administrator to be recommended when the teaching data is insufficient, are each selected. The recommended combination is, for example, a combination in which the core technology of each learning stage, which has been proven in the model development so far, is made into an asset from the development in the information processing system 1 so far.

The information set by the development component is stored in the storage unit 180 as, for example, environment setting information 186.

### [Development Environment]

The development environment (C) shown in FIG. 3 is a specific example of the development environment set by the environment setting unit 140.

Generally, in order to execute machine learning processing, there is a need to prepare a development environment in which the GPU driver, runtime environment, statistics/machine learning library information, OSS library information used for machine learning, etc. are installed on the host OS of the GPU server. In order to execute various OSS on the GPU server, it is necessary to manage a large amount of OSS library information, and the required software configuration differs depending on the OSS library information to be adopted and its version information.

Therefore, standardization of the development environment is performed by using the virtualization platform. For example, by setting the software configuration with a track record of development as a standard virtual environment image in advance by the administrator of the information processing system 1, the user of the information processing system 1 can omit the work related to the environment construction that occurs every time the development is performed. Further, even if the user of the information processing system 1 is unfamiliar with machine learning or a specific OSS, for example, the development results and development environment by other users can be referred to or reused, and the preparation time before starting development can be reduced.

The development environment shows, for example, an environment in which the virtualization platform C-1 is combined with the standard virtual environment image store C-2 and the model management store C-3.

The virtualization platform C-1 is composed of, for example, a GPU server, a host OS of the GPU server, a standard virtual environment, and a model development code. The standard virtual environment is composed of, for example, library information for machine learning, library information for mathematical analysis, a runtime environment, and the like. Details of the standard virtual environment will be described later. The model development code is a programming code created by a user of the information processing system 1.

The standard virtual environment image store C-2 is a store that stores the standard virtual image in the above-described virtualization platform. Here, the standard virtual environment image is realized by using, for example, a virtual environment called a container provided by a specific OSS such as Docker (registered trademark). The environment setting unit 140 stores, for example, the standard virtual environment image store C-2 in the storage unit 180 as environment setting information 186.

The model management store C-3 is, for example, a combination of the model development code, the trained model 187 generated as a result of the model development code being implemented and machine learning being executed, and the virtual environment image. The virtual environment image may be the standard virtual environment image store C-2, or may be one that stores (preserves) the image of the development environment in which the user of the information processing system 1 has changed the settings of the standard virtual environment image store C-2.

### [Development Standard]

The development standard (D) shown in FIG. 3 is a guideline or a convention provided to the user of the information processing system 1 in the entire process. Development standards include, for example, model development process standard 181 model design standard 182, and model design document template 183.

The model development process standard 181 stores, for example, a model development procedure and a guideline for defining a product to be created in each procedure. The model development procedure is defined by, for example, a work item name, a purpose, a start condition, an end condition, an input product, a work content, an output product, a model design document template to be used, and the like.

The model design standard 182 is a guideline that specifically explains, for example, the work items of the model development process standard described above and their deliverables based on the case of the OSS software used and the development environment.

The model design document template 183 includes, for example, a table of contents structure of the model design document and a document template that defines the contents to be described. The deliverables to be created are determined for each work in the development process, and their templates are defined.

By providing these development standards, the user of the information processing system 1 can reduce the time required for trial and error in model development and avoid omissions and defects in the design work. In addition, by further defining the points to be used in other components of the machine learning development platform (base for developing machine learning models) by providing these development standards, it is possible to accumulate model development know-how and promote the use of machine learning development infrastructure.

### [Usage Case]

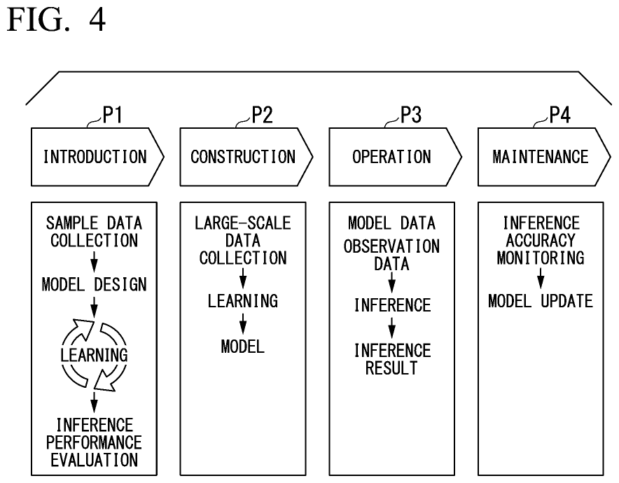

FIG. 4 is a diagram explaining a usage case of the information processing system 1. As shown in FIG. 4, the usage case of the information processing system 1 can be represented by four phases of introduction phase P1, construction phase P2, operation phase P3, and maintenance phase P4.

In the introduction phase P1, for example, a model design is performed using sample data collected by a user of the information processing system 1. The model processing unit 150 generates a trained model 187 by performing a learning processing using the design result and further performing an inference performance evaluation.

In the construction phase P2, for example, the learning processing is advanced using the large-scale data collected by the user of the information processing system 1. The model processing unit 150 improves the learning accuracy of the trained model 187 by reflecting the learning processing result using the large-scale data in the trained model 187 generated in the introduction phase P1.

In the operation phase P3, for example, the user of the information processing system 1 performs inference processing based on the model data and the observation data, and performs model evaluation based on the inference result. The model processing unit 150 weights each edge according to the result of model evaluation, reflects the weighting as a parameter of the trained model 187, and further enhances the learning accuracy of the trained model 187. The trained model 187 at this point is separately stored, for example, as a deliverable model to be delivered to the customer.

In the maintenance phase P4, for example, by monitoring the inference accuracy of the trained model 187 generated in the operation phase P3, it is determined whether or not the trained model 187 needs to be updated. When determining that it is better to update the trained model 187, the user of the information processing system 1 performs the processing of updating the trained model 187 by the model processing unit 150 in the same manner as in the construction phase P2 and the operation phase P3.

### [Specific Examples of Usage Cases]

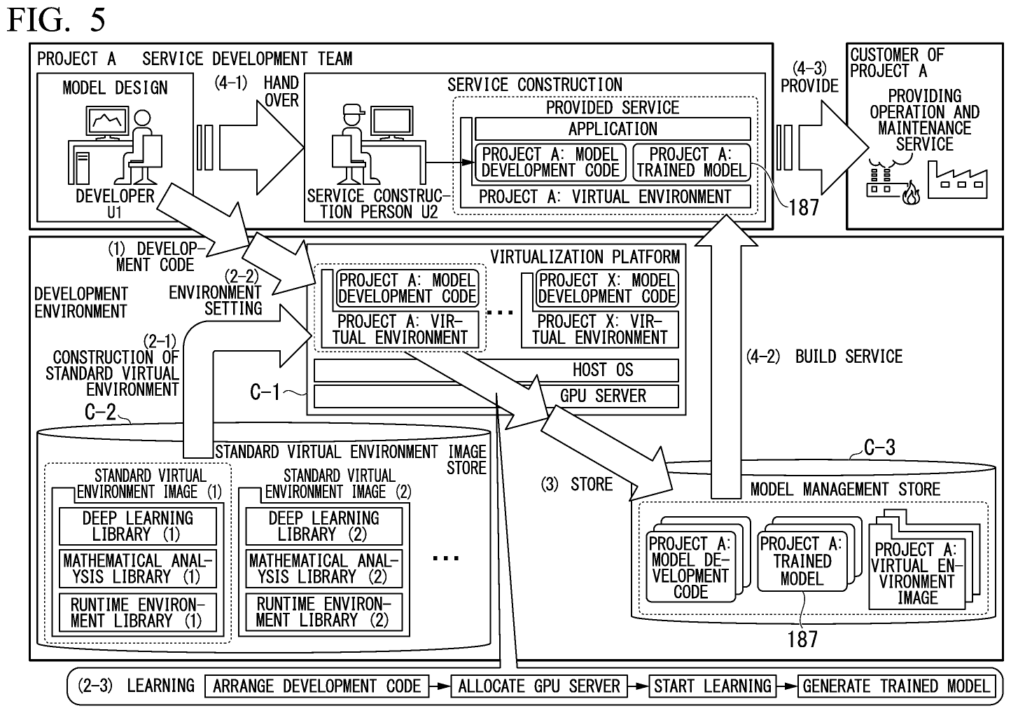

Hereinafter, an example of the processing flow of the information processing system 1 will be described according to the usage case until the trained model 187 generated by the user of the information processing system 1 is provided to the customer. FIG. 5 is a diagram showing a specific example of a usage case of the information processing system 1.

### [Introduction Phase P1]

The developer U1 of the service development team of the project A, which is the user of the information processing system 1, designs the model according to the project A. The acquisition unit 130 acquires the development code generated by the developer U1 via the communication unit 110 ((1) in FIG. 5).

Next, the environment setting unit 140 builds an environment for executing the development code. The environment setting unit 140 starts construction of a standard virtual environment selected by the developer U1 as a development environment for executing the development code transmitted by the developer U1 ((2-1) in FIG. 5).

Next, the environment setting unit 140, for example, performs the environment setting by accepting the setting operation by the developer U1, and applies the development component reflecting the characteristics of the target data in the project A to the standard virtual environment, to construct the virtual environment on the virtualization platform C-1 ((2-2) in FIG. 5).

In addition, in (2-1) and (2-2) in FIG. 5, when the developer U1 does not accept a special designation, or when the developer U1 accepts an operation indicating that a standard virtual environment is set in the information processing system 1, the interface providing unit 170 may output the standard virtual environment selected from the standard virtual environment image store.

Next, the model processing unit 150 arranges the development code of the project A on the virtualization platform C-1. Next, the model processing unit 150 allocates the GPU server for the learning processing to the development code of the project A, and starts the learning processing using the sample data. The model processing unit 150 generates a trained model 187 as a result of the learning processing ((2-3) in FIG. 5). The development code at this stage, the trained model 187, and the virtualization platform C-1 are stored in the model management store C-3. The virtualization platform C-1 may be stored in an image format.

### [Construction Phase P2]

The model processing unit 150 further performs the learning processing shown in FIG. 5 (2-3) using the large-scale data, and further updates the trained model 187 by reflecting the weighting update and the like by the inference processing (FIG. 5 (3)). The updated trained model 187 and setting information such as weighting may be sequentially overwritten and saved in the model management store C-3, or may be saved at each update stage.

### [Operation Phase P3]

When the developer U1 determines that the learning of the trained model 187 of the project A has progressed and the output accuracy of the trained model 187 has sufficiently improved, the trained model 187 is handed over to the service construction person U2 (FIG. 5 (4-1)). The management unit 160 receives, for example, an operation by the developer U1 indicating that the phase has moved to the operation phase P3 (such as linking the service construction person U2 of the user information 184 to the project A, or granting the disclosure authority to the service construction person U2 to the environment setting information 186 of the corresponding environment. As a result, the management unit 160 allows the service construction person U2 to access the development code of the project A, the trained model 187, and the virtualization platform C-1 stored in the model management store C-3.

The service construction person U2 applies, for example, the development code of the project A, the trained model 187, and the virtualization platform C-1 stored in the model management store C-3 to the dedicated environment for the customer of the project A to build the service ((4-2) in FIG. 5), and starts providing operation and maintenance services to the customers of the project A ((4-3) in FIG. 5).

### [Maintenance Phase P4]

The service construction person U2 monitors, for example, the inference accuracy of the trained model 187 provided to the customer of the project A.

### [Generation of Processing Flow Trained Model 187]

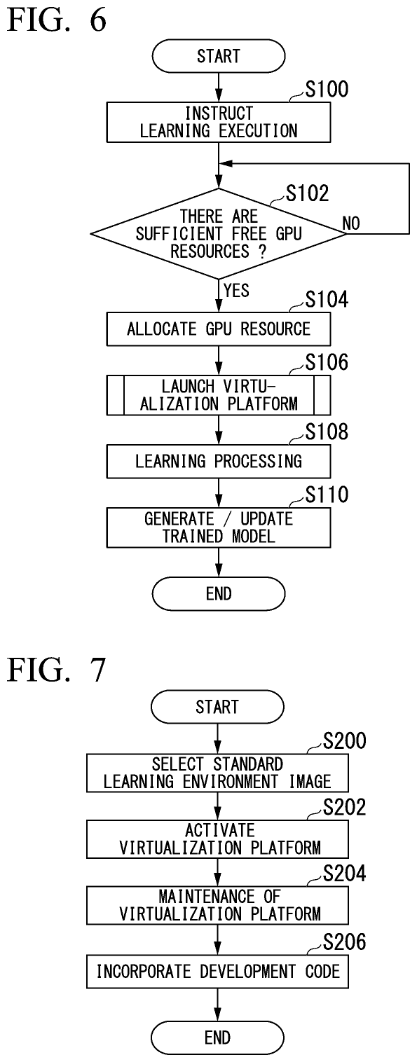

FIG. 6 is a flowchart showing an example of the flow of learning processing by the model processing unit 150. The process shown in FIG. 6 is, for example, a process performed when the trained model 187 is generated/updated in each of the phases P1 to P4 shown in FIG. 4.

The communication unit 110 receives a learning execution instruction from the user of the information processing system 1 (step S100). The acquisition unit 130 may acquire the development code and the target data at the time of step S100, for example. Next, the model processing unit 150 checks the resources of the GPU server and determines whether or not there are sufficient free resources (step S102). When the model processing unit 150 does not determine that there are sufficient free resources, the model processing unit 150 waits for a predetermined time and executes step S102 again. When the model processing unit 150 determines that there are sufficient free resources, it allocates a GPU server for learning (step S104). Next, the model processing unit 150 launches the virtualization platform C-1 which is a learning execution environment (step S106), and starts the learning processing (step S108). Next, the model processing unit 150 stores the trained model 187 generated or updated as a result of the learning processing in the storage unit 180 (step S110). This is the end of the description of the processing of this flowchart.

### [Launch of Processing Flow Virtualization Platform]

FIG. 7 is a flowchart showing an example of the processing flow of the virtualization platform C-1 which is the learning execution environment. FIG. 7 corresponds to the processing breakdown of step S106 of FIG. 6.

First, the model processing unit 150 expands the standard virtual environment image store C-2 and provides the virtualization platform C-1 (step S200). Next, the model processing unit 150 activates the virtualization platform C-1 (step S202). Next, the environment setting unit 140 prepares the virtualization platform C-1 by setting changes such as parameters (step S204). Next, the model processing unit 150 incorporates the development code into the prepared virtualization platform C-1 (step S206). This is the end of the description of the processing of this flowchart.

### [Interface Provided]

The processing by the interface providing unit 170 will be described below. The interface providing unit 170 refers to the access authority of the user of the information processing system 1 output by the management unit 160 and the disclosure range set in the trained model 187, and outputs the development interface so that the user can easily start the development. The development interface is, for example, the framework environment and library information set by the environment setting unit 140, the image store of the virtualization platform C-1 including the development code, the trained model 187, and some or all of various types of document information.

Hereinafter, a specific example will be described. It is assumed that the developer U1 has completed the development of the project A shown in FIG. 5 and is developing another project B. Further, it is assumed that the service construction person U2 is carrying out the maintenance of the project A shown in FIG. 5. Further, it is assumed that the other user U3 has just started to use the information processing system 1 and is about to start the development with reference to the information obtained by the management unit 160. The user U3 will be described as not being related to the projects A and B.

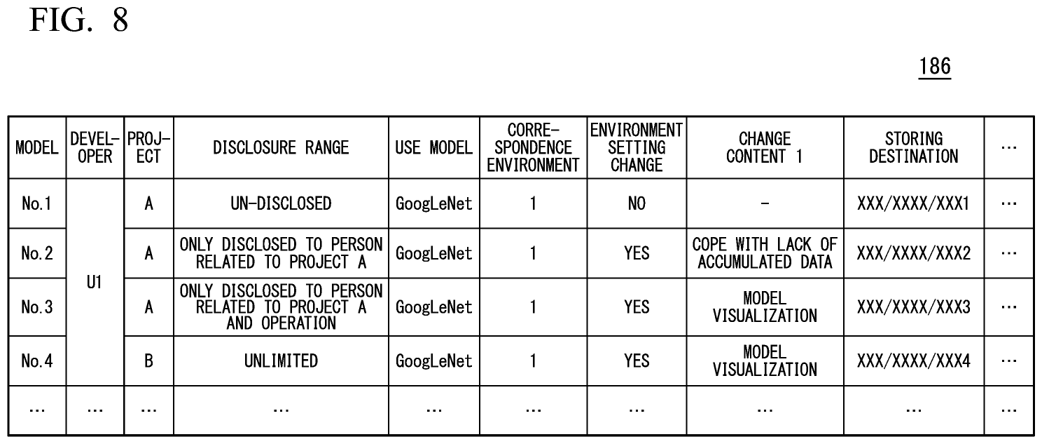

FIG. 8 is a diagram showing an example of the contents of the environment setting information 186. The environment setting information 186 is, for example, information in which information such as the developer of the model, the project, the disclosure range of the model, the usage model, the corresponding standard virtualization platform C-1, whether or not the environment settings have been changed, the details of the changes, and the model save destination is associated with a number for identifying each trained model.

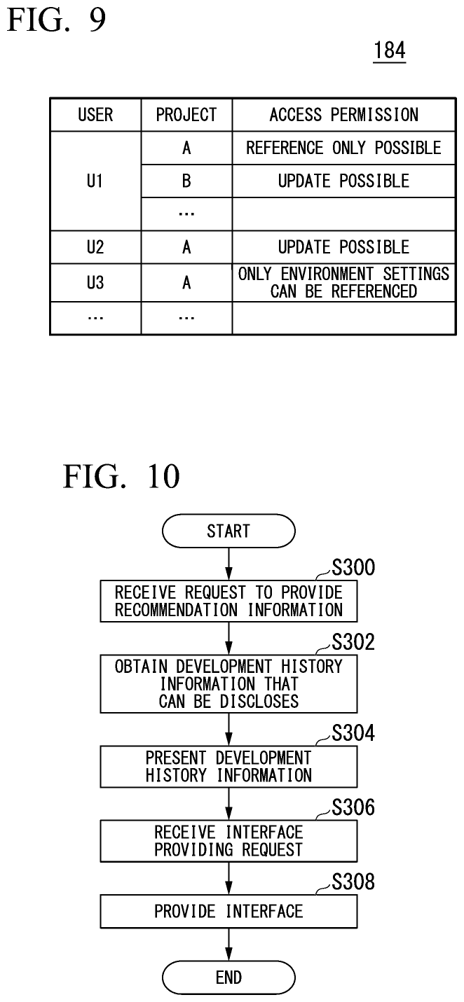

FIG. 9 is a diagram showing an example of the contents of the user information 184. In the user information 184, for example, a project and access authority for the environment setting information 186 of the project are stored for each user.

The management unit 160 receives, for example, an operation instruction to output interface information that can be referred to by the user U3. The management unit 160 searches for the interface information that can be provided to the user U3 by referring to the environment setting information 186 and the user information 184.

The management unit 160, for example, provides the user U3 with the interface information of the trained model 187 of the model No. 4 as search information obtained with reference to FIGS. 8 and 9. The user U3 can start development by referring to this information and development standards such as the development interface provided by the interface providing unit 170, model development process standard 181, model design standard 182, and model design document template 183.

The interface information provided by the interface providing unit 170 may be, for example, for the user U3, some or all of the information about the model No. 4 or may be information that refers to the virtualization platform C-1 that develops the model No. 4. For example, when the interface providing unit 170 refers to the virtualization platform C-1 used in a past project, the user U3 can use the virtualization platform C-1 that reflects the software configuration that has been developed by other users, and can easily perform environment construction work and can try the learning processing in a proven development environment. Further, the user U3 can start coding with reference to at least the development code created by the developer U1 applied to the virtualization platform C-1.

Further, the management unit 160 may, for example, have the administrator of the information processing system 1 set the virtualization platform C-1 to be preferentially referred to by other users and the environment setting information 186.

Further, the management unit 160 may receive, for example, the type and problem characteristics of the target data from the user as input information, and display the appropriate virtualization platform C-1 and the trained model 187 as recommended information by referring to the input information. The interface providing unit 170 receives information such as “input data is image data” and “input data is sensor data” from the user, and displays the virtualization platform C-1 and the environment setting information 186 using the same input data as recommendation information.

### [Providing Processing Flow Interface]

FIG. 10 is a flowchart showing an example of the flow of the interface providing process by the management unit 160 and the interface providing unit 170.

First, the management unit 160 receives a request from the user to provide the recommendation information (step S300). Next, the management unit 160 searches the user information 184 and the environment setting information 186, and obtains a search result of the environment setting information 186 corresponding to the development history information in a disclosable range according to the access authority of the user (Step S302). Next, the management unit 160 presents the development history information of the search result to the user (step S304). Next, the interface providing unit 170 receives the interface providing request from the user (step S306). The interface provision request received here may be a request for a copy environment of any of the development history information selected by the user, or may be a request for the provision of a standard virtual environment. Next, the interface providing unit 170 provides the requested development interface to the user (step S308). This is the end of the description of the processing of this flowchart.

According to at least one embodiment described above, it is possible to standardize the model development technique by the user of the information processing system 1, by having the acquisition unit 130, which acquires the design information such as the development code for performing machine learning and the large-scale data and sample data to be the target data of the machine learning; the environment setting unit 140, which sets the virtualization platform C-1 that corresponds to the framework environment and library information that executes the design information acquired by the acquisition unit 130 and the software configuration of software information 185 that assists the execution of machine learning processing according to the version information of the framework environment and library information; the model processing unit 150, which generates or updates the trained model 187 by executing the learning for the target data using the virtualization platform C-1 that reflects the design information acquired by the acquisition unit 130 and the framework environment set by the environment setting unit 140; the management unit 160, which manages the design information acquired by the acquisition unit 130, information on the framework environment set by the environment setting unit 140, and information about the trained model 187 generated or updated by the model processing unit 150 as development history information as model management store C-3 or the like; the interface providing unit 170, which accepts the output instruction of the environment setting information from the user of the information processing system 1 and presents the setting information recommended to the user to use the standard virtualization platform C-1 based on the setting information selected by the user; and the control unit 120, which controls and links the input and output of information of each component of the the acquisition unit 130, the environment setting unit 140, the management unit 160, and the interface providing unit 170.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
an acquisition unit configured to acquire design information for machine learning and target data for the machine learning;
an environment setting unit configured to set a framework environment and library information for executing the design information acquired by the acquisition unit, and a software configuration for assisting an execution of the machine learning in the framework environment according to version information of the framework environment and the library information;
a model processing unit configured to generate or update a model by executing learning for the target data using the design information acquired by the acquisition unit and the framework environment set by the environment setting unit;
a management unit configured to manage the design information acquired by the acquisition unit, information on the framework environment set by the environment setting unit, and information on the model generated or updated by the model processing unit as development history information;
an interface providing unit configured to receive an output instruction of environment setting information from a user of the own system, present the setting information recommended to the user, and cause the environment setting unit to set the environment based on the setting information selected by the user; and
a control unit configured to link the acquisition unit, the environment setting unit, the management unit, and the interface providing unit.

2. The information processing system according to claim 1, wherein
the environment setting unit receives a request for changing a setting from the user of the information processing system, and provides an environment setting that reflects a received change content, and
the management unit also manages whether or not the setting has been changed.

3. The information processing system according to claim 1, wherein
the management unit recognizes a disclosable range in which the development history information can be disclosed to the user according to an access authority set for the user of the information processing system, and provides the user with the development history information in the recognized disclosable range as recommendation information.

4. An information processing method, wherein
a computer
acquires design information for machine learning and target data for machine learning,
sets a framework environment and library information for executing the acquired design information, and a software configuration for assisting the executing,
generates or updates a model by executing learning on the target data using the design information that has been acquired and the framework environment that has been set, and
manages the design information that has been acquired, information about the framework environment that has been set, and information about the model that has been generated or updated, as development history information.
